(19) United States
(12) Patent Application Publication
(10) Pub. No.: US 2004/0115982 A1
(43) Pub. Date: Jun. 17, 2004

(54) ELECTRICAL CONNECTOR HAVING COMPACT STRUCTURE

(75) Inventors: Jin Min Zeng, Kunsan (CN); FuJin Peng, Kunsan (CN)

Correspondence Address: WEI TE CHUNG, FOXCONN INTERNATIONAL, INC., 1650 MEMOREX DRIVE, SANTA CLARA, CA, 95050, US

(73) Assignee: HON HAI PRECISION IND. CO., LTD, Tu-chen (TW)

(21) Appl. No.: 10/605,774

(22) Filed: Oct. 24, 2003

(30) Foreign Application Priority Data
Dec. 16, 2002 (TW) 91219761

(51) Int. Cl. H01R 13/625

(52) U.S. Cl. 439/342

(57) ABSTRACT

An electrical connector comprises a base (10) electrically connectable to a PCB, a cover (11) slidably mounted on the base, and an actuation device (13) for actuating the cover to slide along the base. The base defines a pair of sidewalls (102) parallel to a sliding direction of the cover, and the cover defines a pair of sidepieces (111) corresponding to the sidewalls. The base defines a plurality of first fastening members (1021) on the sidewalls, and the cover defines a plurality of second fastening members (1111) corresponding to the first fastening members. In addition, the cover defines a plurality of protrusions (1112) on the sidepieces for interfering with the sidewalls of the base, which enables compact engagement after the base and the cover being assembled together. In an alternative embodiment, a plurality of protrusions (1121′) is formed on the sidewalls of the base rather than on the sidepieces of the cover.

### BACKGROUND OF INVENTION

1. Field of the Invention

The present invention relates to an electrical connector connecting an electronic package such as a center processing unit (CPU) to a circuit substrate such as a printed circuit board (PCB), and more particularly to an electrical connector having a base and a cover compactly assembled together.

2. Description of Related Art

A conventional zero insertion force (ZIF) electrical connector is used to electrically connect a CPU to a PCB. The connector comprises a base associated with the PCB, and a cover slidably mounted on the base. Such electrical connectors are disclosed in U.S. Pat. Nos. 5,722,848, 5,833,483, 5,947,778, 6,231,367, and in a related scientific article entitled Development of ZIF BGA Socket (Connector Specifier, May 2000). However, such an electrical connector disclosed in aforementioned issues has certain clearance between the base and the cover thereof, which results in unsteady cooperation between the base and the cover. Because of the clearance, the cover will deflect while the cover slides on the base, which induces deflective motion of conductive pins of the CPU and results in unstable electrical connection between the electrical connector and the CPU.

Hence, a new electrical connector having compact structure is desired to overcome the above-described disadvantages.

### SUMMARY OF INVENTION

A primary object of the present invention is to provide an electrical connector having a base and a cover compactly assembled together.

In order to achieve the aforementioned object, an electrical connector in accordance with a preferred embodiment of the present invention comprises a base electrically connectable to a PCB, a cover slidably mounted on the base, and an actuation device for actuating the cover to slide along the base. The base defines a pair of sidewalls parallel to a sliding direction of the cover, and the cover defines a pair of sidepieces corresponding to the sidewalls. The base defines a plurality of first fastening members on the sidewalls, and again, the cover defines a plurality of second fastening members corresponding to the first fastening members, therefore, the base and the cover can be assembled together by virtue of the cooperation of the first and second fastening members. In addition, the cover defines a plurality of protrusions on the sidepieces for interfering with the sidewalls of the base, which enables compact engagement after the base and the cover being assembled together. In an alternative embodiment, a plurality of protrusions is formed on the sidewalls of the base rather than on the sidepieces of the cover.

Other objects, advantages and novel features of the present invention will become more apparent from the following detailed description when taken in conjunction with the accompanying drawings, in which:

### BRIEF DESCRIPTION OF DRAWINGS

FIG. 1 is an isometric view of an electrical connector in accordance with a preferred embodiment of the present invention;

FIG. 2 is an exploded view of FIG. 1;

FIG. 3 is an isometric view of a cover of the electrical connector of FIG. 2, but showing the cover inverted;

FIG. 4 is an exploded isometric view of an electrical connector in accordance with an alternative embodiment of the present invention.

### DETAILED DESCRIPTION

Reference will now be made to the drawing figures to describe the present invention in detail.

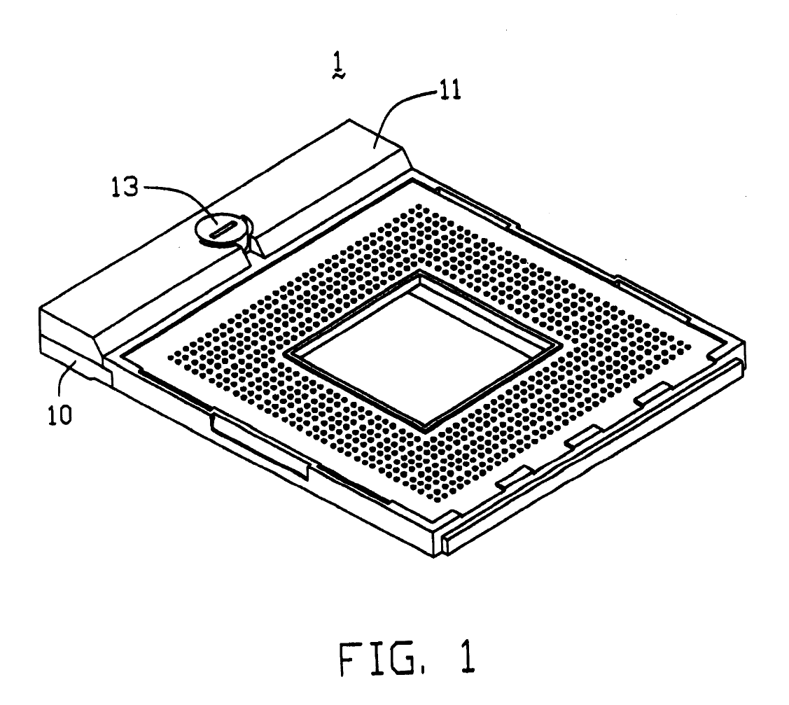

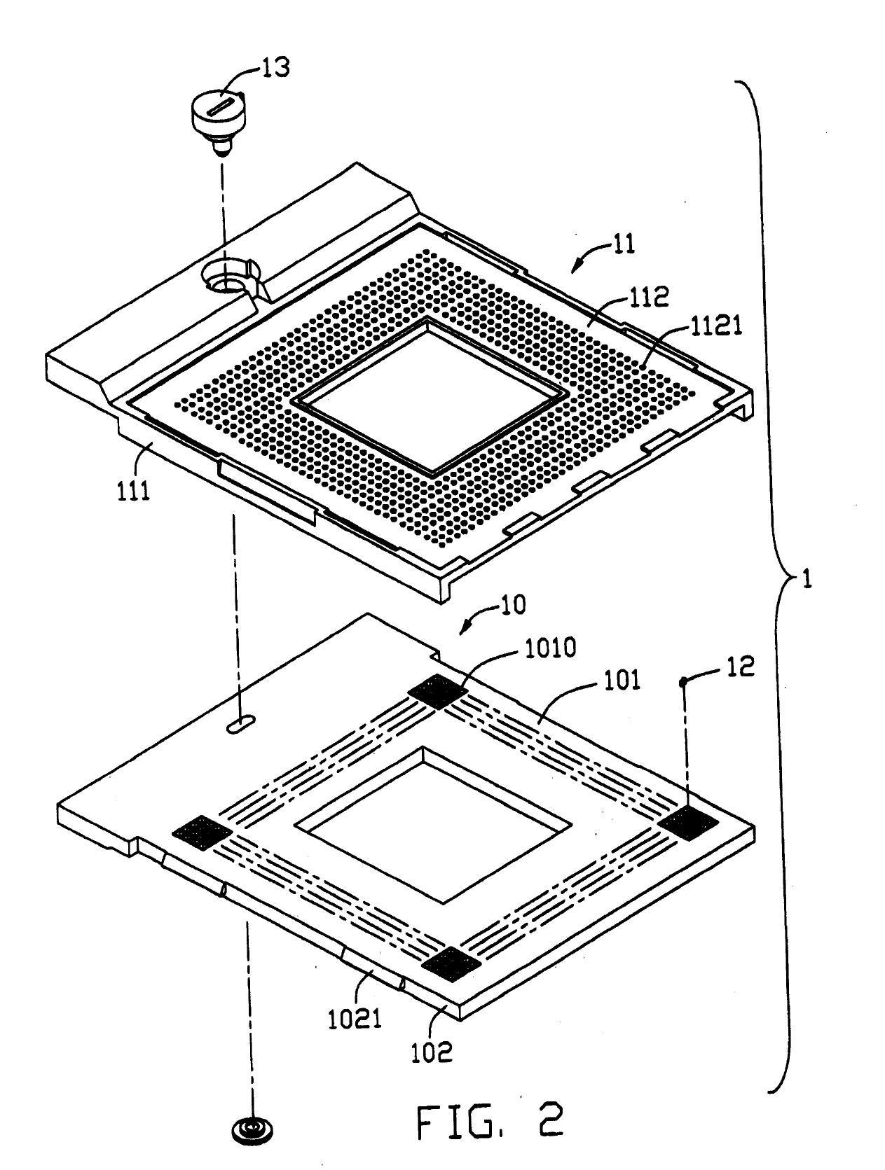

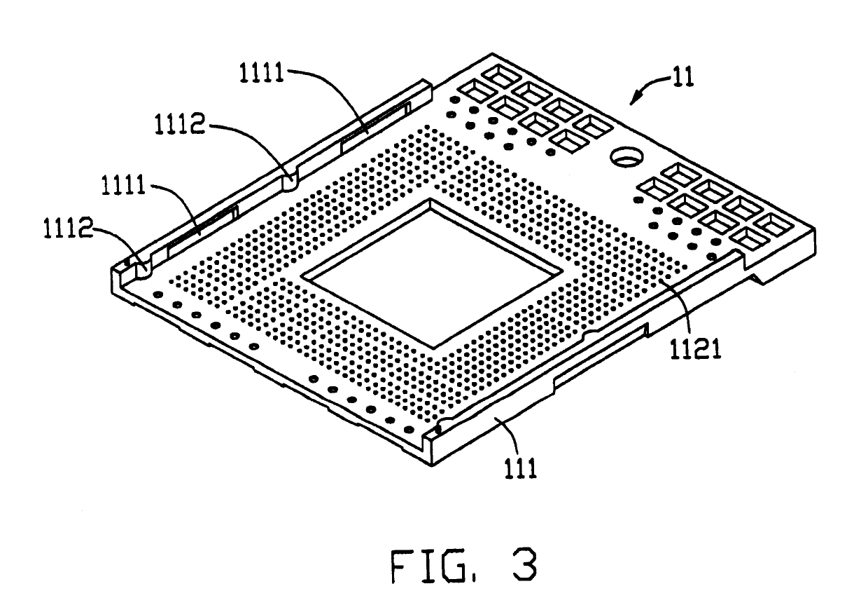

Referring to FIGS. 1-3, an electrical connector 1 of the present invention is adapted to electrically connect an electronic package such as a center processing unit (CPU, not shown) to a circuit substrate such as a printed circuit board (PCB, not shown). The electrical connector 1 comprises an insulative base 10 electrically connectable to the PCB, a cover 11 slidably mounted on the base 10, and an actuation device 13, for actuating the cover 11 to slide along the base 10, extending through and attached to the base 10 and the cover 11.

The base 10 comprises a mating body 101 adapted to slidably support the cover 11 thereon and a pair of parallel sidewalls 102 perpendicular to the mating body 101. The mating body 101 defines a plurality of passageways 1010 therethrough for accommodating a plurality of corresponding conductive terminals 12 therein. Each sidewall 102 fabricates a plurality of first fastening members 1021 thereon.

The cover 11 is used for carrying the CPU thereon. The cover 11 defines two parallel sidepieces 111 corresponding to the sidewalls 102 of the base 10 and a supporting body 112 connecting the two sidepieces 111, wherein the supporting body 112 is used for carrying the CPU thereon and defines a plurality of through holes 1121 corresponding to the passageways 1010 of the base 10. Each sidepiece 111 fabricates a plurality of second fastening members 1111 thereon for engaging with the first fastening members 1021. In addition, each sidepiece 111 of the cover 11 forms a plurality of protrusions 1112 spaced apart from the second fastening members 1111. When the cover 11 is mounted onto the base 10, the first and the second fastening members 1021, 1111 cooperate with each other for attaching the cover 11 on the base 10, and the sidepieces 111 interferes with the sidewalls 102 by virtue of the protrusions 1112.

When the base 10 and the cover 11 are assembled together, the base 10 and the cover 11 are movable relative to each other between an open position and a closed position by rotating the actuation device 13. In the open position, the cover 11 is located on the base 10 and is offset from the base 10 a predetermined distance. When the CPU is put on the cover 11 with its conductive pins extending through the through holes 1121 of the cover 11 and the passageways 1010 of the base 10, an external tool is applied to compel the actuation device 13 to rotate at a predetermined angle for actuating the cover 11 to slide along the base 10 until the cover 11 is in the closed position. The protrusions 1112 defined on the sidepieces 111 of the cover 11 facilitate more compact engagement between the base 10 and cover 11.

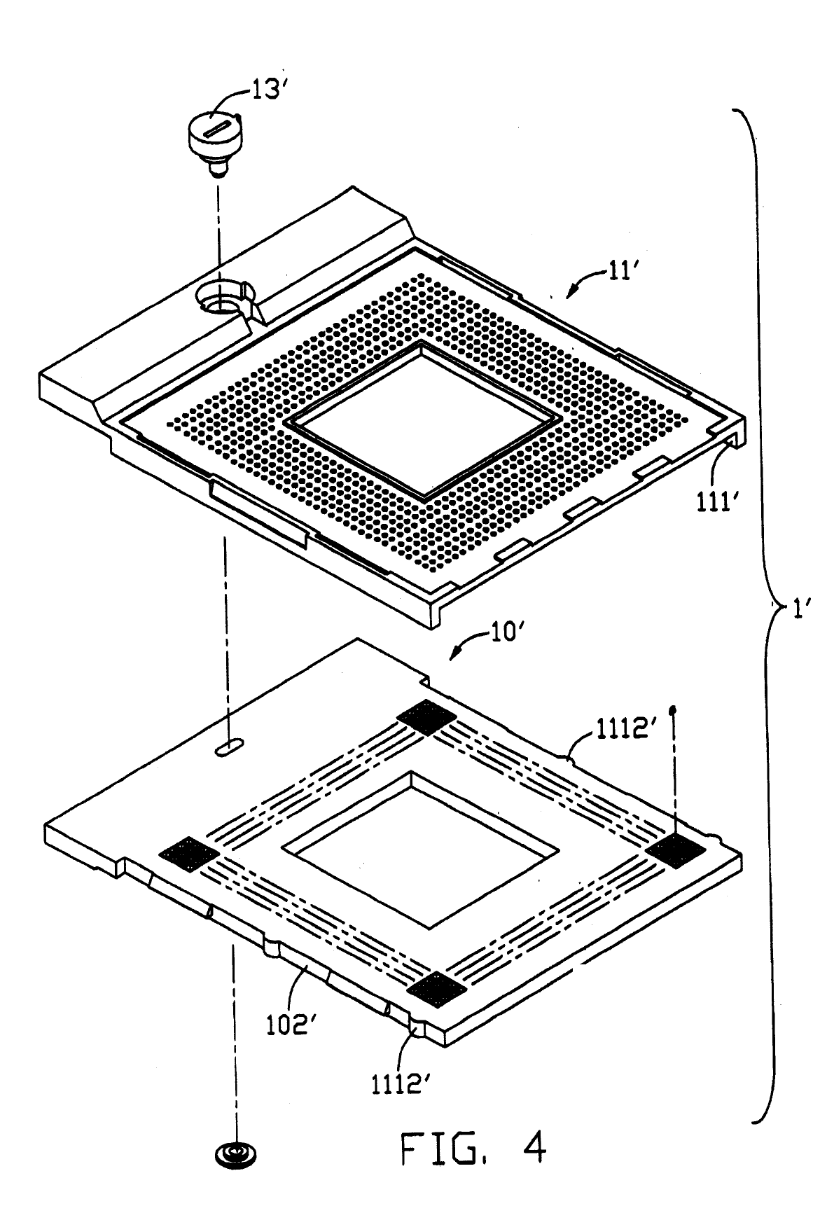

Referring to FIG. 4, an electrical connector 1′ in accordance with an alternative embodiment of the present invention has a structure similar to that of the electrical connector 1 of the preferred embodiment. The electrical connector 1′ comprises a base 10′ mounted on a PCB (not shown), a cover 11′ located on the base 10′ and an actuation device 13′, for actuating the cover 11′ to slide along the base 10′, extending through and attached to the base 10′ and the cover 11′. The base 10′ defines a pair of sidewalls 102′ and the cover 11′ defines a pair of sidepieces 111′ corresponding to the sidewalls 102′. In addition, each sidewall 102′ of the base 10′ forms a plurality of protrusions 1112′ thereon. When the base 10′ and the cover 11′ are assembled together, the sidewalls 102′ interferes with the sidepieces 111′ by virtue of the protrusions 1112′. The electrical connector 1′ can perform substantially the same functions as described above in relation to the electrical connector 1 of the preferred embodiment.

While the present invention has been described with reference to specific embodiments, the description is illustrative of the invention and is not to be construed as limiting the invention. Various modifications to the present invention can be made to the preferred embodiments by those skilled in the art without departing from the true spirit and scope of the invention as defined by the appended claims.

1. An electrical connector for electrically connecting an electronic package to a circuit substrate, the electrical connector comprising:
a base defining a plurality of passageways and a pair of sidewalls forming a plurality of first fastening members;
a plurality of conductive terminals received in the passageways;
a cover slidably mounted on the base and defining a plurality of through holes corresponding to the passageways of the base and a pair of sidepieces corresponding to the sidewalls of the base, each sidepiece forming a plurality of second fastening members engaging with the first fastening members;
an actuation device attached to the base and the cover for actuating the cover to slide along the base; wherein
a plurality of protrusions is provided on one of the sidewalls and the sidepieces for facilitating compact engagement between the base and the cover.

2. The electrical connector as described in claim 1, wherein the protrusions are provided on the sidepieces of the cover.

3. The electrical connector as described in claim 2, wherein the protrusions are spaced apart from the second fastening members.

4. The electrical connector as described in claim 1, wherein the protrusions are provided on the sidewalls of the base.

5. The electrical connector as described in claim 4, wherein the protrusions are spaced apart from the first fastening members.

6. An electrical connector for carrying a CPU thereon, comprising:
a base defining a plurality of passageways and a pair of sidewalls forming a plurality of first fastening members;
a plurality of conductive terminals received in the passageways;
a cover slidably mounted on the base and defining a plurality of through holes corresponding to the passageways of the base and a pair of sidepieces corresponding to the sidewalls of the base, each sidepiece forming a plurality of second fastening members engaging with the first fastening members;
an actuation device attached to the base and the cover for actuating the cover between an open position and a closed position; wherein
a plurality of protrusions is provided on one of the base and the cover for facilitating compact engagement between the base and the cover.

7. The electrical connector as described in claim 6, wherein the protrusions are provided on the sidepieces of the cover.

8. The electrical connector as described in claim 6, wherein the protrusions are provided on the sidewalls of the base.

9. The electrical connector as described in claim 7, wherein the protrusions are spaced apart from the second fastening members.

10. The electrical connector as described in claim 8, wherein the protrusions are spaced apart from the first fastening members.

11. An electrical connector comprising:
a base defining a plurality of passageways;
a first surface formed on the base;
a plurality of terminals disposed in the corresponding passageways, respectively;
a plurality of first fastening devices formed on the first surface of the base;
a cover mounted upon the base and moveable relative to the base along a front-to-back direction, said cover defining a plurality of through holes substantially in alignment with the corresponding passageways in a vertical direction perpendicular to said front-to-back direction, respectively;
a second surface formed on the cover and opposing to said first surface with a tiny distance therebetween; and
a plurality of second fastening devices formed on the second surface of the cover and latched to said first fastening devices, respectively, under a condition that the first and second fastening devices are allowed to be moveable, relative to each other, along said front-to-back direction while immoveable in said vertical direction; wherein
at least one tiny protrusion is formed on one of said first and second surfaces to constantly abut against the other of said first and second surfaces during a back-and-forth movement of the cover relative to the base along said front-to-back direction, so as to, during said back-and-forth movement, prevent movement of the cover relative to the base in a lateral direction perpendicular to said front-to-back and vertical directions.

12. The connector as described in claim 11, wherein said tiny protrusion is positioned offset from either the first fastening devices or the second fastening devices along said front-to-back direction.
